(19) United States
(12) Patent Application Publication
(10) Pub. No.: US 2025/0134120 A1
(43) Pub. Date: May 1, 2025

(54) FOOD PRESERVATIVE, METHOD OF PREPARATION THEREOF, AND METHOD OF ROOM-TEMPERATURE PRESERVATION

(71) Applicants: Innovation Center of Yangtze River Delta, ZJU, Jiaxing City (CN); Zhejiang Shenjinji Food Technology Co., Ltd., Huzhou City (CN)

(72) Inventors: Ziyi HU, Jiaxing City (CN); Daxi REN, Jiaxing City (CN); Aixia HUANG, Jiaxing City (CN); Jiamin SHEN, Jiaxing City (CN)

(73) Assignees: Innovation Center of Yangtze River Delta, ZJU, Jiaxing City (CN); Zhejiang Shenjinji Food Technology Co., Ltd., Huzhou City (CN)

(21) Appl. No.: 18/608,600

(22) Filed: Mar. 18, 2024

(30) Foreign Application Priority Data
Oct. 25, 2023 (CN) 2023113896204

(51) Int. Cl. A23B 4/20; A23B 4/12; A23L 3/3472; A23L 3/349; A23L 3/3499; A23L 3/3508; A23L 3/3562

(52) U.S. Cl. CPC A23B 4/20; A23B 2/733; A23B 2/746; A23B 2/75; A23B 2/754; A23B 2/779; A23B 4/12

(57) ABSTRACT

Some embodiments of food preservatives, methods of preparation thereof, and methods of room-temperature preservation, in the technical field of food preservation, are disclosed. In some embodiments, the food preservative includes chitosan, Chinese prickly ash oil, and astaxanthin. In other embodiments, the food preservative includes glycerol, acetic acid, and water. In further embodiments, the glycerol, the acetic acid, and the water are at a volume ratio of 5-30:5-25:915-985, and the chitosan and the water are at a mass-volume ratio of 5-20 g:915-985 mL. In some embodiments, the Chinese prickly ash oil, the chitosan, and the astaxanthin are at a volume-mass-mass ratio of 5-30 mL:5-20 g:0.01-0.06 g.

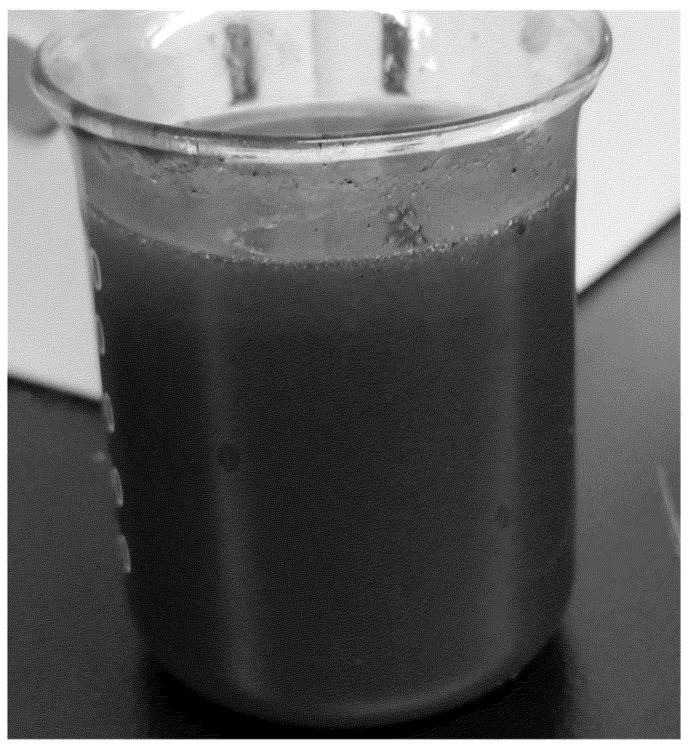

### CROSS REFERENCE TO RELATED APPLICATIONS

This application claims priority to Chinese patent application number 2023113896204, filed on Oct. 25, 2023, the disclosure of which is incorporated by reference herein in its entirety.

### FIELD OF THE DISCLOSURE

The disclosure relates generally to the field of food preservation. More specifically, the disclosure relates to food preservatives, methods of preparation thereof, and methods of room-temperature preservation.

### BACKGROUND

China is a major meat consumer, with fresh meat products accounting for the majority. However, fresh meat is frequently contaminated by pathogenic bacteria such as Salmonella spp., Listeria spp., and Staphylococcus aureus during slaughtering and cutting. At present, industrial sterilization mainly involves spraying on the surface of meat with steam or organic acid, which hardly removes pathogenic bacteria and spoilage bacteria inside the meat. Therefore, the safety and quality problems of fresh meat have always been common. In addition, the sales and transportation of meat have gradually shifted towards the “home delivery” mode with the rise of e-commerce platforms, and traditional cold chain transportation can no longer meet the demands of novel mode for meat production and sales. In China, many e-commerce companies generally transport meat by room-temperature logistics in order to meet the customers' home delivery needs at the lowest cost. In this way, the safety and quality of fresh meat become even more uncontrollable. In view of this, the research on sterilization and preservation technology that can effectively improve the safety and quality of fresh meat as well as match the existing novel meat production and marketing mode is of great significance to protect people's health and promote the sustainable development of the meat industry.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a food preservative, including Chinese prickly ash oil, chitosan, and astaxanthin.

Optionally, the food preservative further including glycerol, acetic acid, and water.

Optionally, the glycerol, the acetic acid, and the water are at a volume ratio of 5-30:5-25:915-985, and the chitosan and the water are at a mass-volume ratio of 5-20 g:915-985 mL.

Optionally, the Chinese prickly ash oil, the chitosan, and the astaxanthin are at a volume-mass-mass ratio of 5-30 mL:5-20 g:0.01-0.06 g.

In other embodiments, the disclosure provides a method for preparing the food preservative including following steps: mixing chitosan with acetic acid and water to obtain a chitosan solution, mixing the Chinese prickly ash oil, glycerol, and the astaxanthin to obtain a complex liquid, and mixing the chitosan solution with the complex liquid to obtain a chitosan-Chinese prickly ash oil-astaxanthin composite preservative.

Optionally, the food preservative further includes glycerol, acetic acid, and water.

Optionally, the glycerol, the acetic acid, and the water are at a volume ratio of 5-30:5-25:915-985, and the chitosan and the water are at a mass-volume ratio of 5-20 g:915-985 mL.

Optionally, the food preservative further includes glycerol, acetic acid, and water.

Optionally, the glycerol, the acetic acid, and the water are at a volume ratio of 5-30:5-25:915-985, and the chitosan and the water are at a mass-volume ratio of 5-20 g:915-985 mL.

Optionally, the Chinese prickly ash oil, the chitosan, and the astaxanthin are at a volume-mass-mass ratio of 5-30 mL:5-20 g:0.01-0.06 g.

Optionally, the chitosan solution includes 5 g/L to 20 g/L of chitosan by concentration.

Optionally, the Chinese prickly ash oil, the chitosan, and the astaxanthin are at a volume-mass-mass ratio of 5-30 mL:5-20 g:0.01-0.06 g.

In further embodiments, the disclosure provides a method of room-temperature preservation of a food product, including: coating the food preservative on a surface of the food product, air-drying, and packaging.

Optionally, the food product includes a meat product.

Optionally, 400 μL of the food preservative is coated on per 1 g to 2 g of the meat product.

Optionally, the method further including vacuum packaging after the air-drying is completed.

In some embodiments, the present disclosure provides a food preservative, including Chinese prickly ash oil, chitosan, and astaxanthin.

In some embodiments, the food preservative further includes glycerol, acetic acid, and water.

In some embodiments, the Chinese prickly ash oil, the chitosan, and the astaxanthin are at a volume-mass-mass ratio of (5-30) mL:(5-20) g:(0.01-0.06) g.

In some embodiments, the glycerol, the acetic acid, and the water are at a volume ratio of (5-30):(5-25):(915-985), and the chitosan and the water are at a mass-volume ratio of (5-20) g:(915-985) mL.

The present disclosure further provides a method for preparing the food preservative, including the following steps: mixing the chitosan with the acetic acid and the water to obtain a chitosan solution, mixing the Chinese prickly ash oil, the glycerol, and the astaxanthin to obtain a complex liquid, and mixing the chitosan solution with the complex liquid to obtain a chitosan-Chinese prickly ash oil-astaxanthin composite preservative.

In some embodiments, the chitosan solution has 5 g/L to 20 g/L of chitosan by concentration.

The present disclosure further provides a method for room-temperature preservation of a food product, including: coating the food preservative on a surface of the food product, air-drying, and packaging.

### BRIEF DESCRIPTION OF THE DRAWING

Illustrative embodiments of the present disclosure are described in detail below with reference to the attached drawing FIGURE.

The FIGURE shows a picture of the food preservative according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

The present disclosure provides a food preservative shown in the FIGURE, including Chinese prickly ash oil, chitosan, and astaxanthin.

In the present disclosure, the food preservative further includes optionally glycerol, acetic acid, and water. The Chinese prickly ash oil, the chitosan, and the astaxanthin are at a volume-mass-mass ratio of optionally (5-30) mL:(5-20) g:(0.01-0.06) g. The glycerol, the acetic acid, and the water are at a volume ratio of optionally (5-30):(5-25):(915-985), and the chitosan and the water are at a mass-volume ratio of optionally (5-20) g:(915-985) mL.

In the present disclosure, the above three raw materials are optionally all food grade, and the astaxanthin is optionally a product containing the astaxanthin, such as an astaxanthin powder derived from Haematococcus pluvialis, with an astaxanthin content of 2%.

The present disclosure further provides a preparation method of the food preservative, including the following steps: mixing the chitosan with the acetic acid and the water to obtain a chitosan solution, mixing the Chinese prickly ash oil, the glycerol, and the astaxanthin to obtain a complex liquid, and mixing the chitosan solution with the complex liquid to obtain a chitosan-Chinese prickly ash oil-astaxanthin composite preservative.

In the present disclosure, the chitosan solution has optionally 5 g/L to 20 g/L of chitosan by concentration.

The present disclosure further provides a method for room-temperature preservation of a food product, including: coating the food preservative on a surface of the food product, air-drying, and packaging.

In the present disclosure, the food product optionally includes a meat product, such as poultry meat and livestock meat. When using the food preservative to preserve the meat product, 400 μL of the food preservative is optionally used for per 1 g to 2 g of the meat product, and then the meat product is air-dried for 15 min before the packaging. The packaging optionally includes vacuum packaging.

To further describe the present disclosure, the food preservative and the method of preparation thereof, and the method of room-temperature preservation according to the present disclosure are described in detail below with reference to specific examples. However, these examples should not be construed as limitations to the protection scope of the present disclosure.

Unless otherwise specified, the experimental consumables and reagents used in the examples of the present disclosure are commercially available.

### Example 1

1) Every 10 g of a food-grade chitosan powder (molecular weight 300 kDa, deacetylation degree 95%, purchased from Shengjiade Biotechnology Co., Ltd.) was added with 200 mL of edible white vinegar (acetic acid content 5%, purchased from Qianhe Condiment And Food Co., Ltd.) and 760 mL of distilled water, and mixed thoroughly to obtain a chitosan solution.

2) Every 3 g of a food-grade Haematococcus pluvialis-derived astaxanthin powder (astaxanthin content 2%, purchased from Shanghai Xintai Industrial Co., Ltd.) was added with 20 mL of food-grade Chinese prickly ash oil (purchased from Qingdao Xiangbaer Food Additives Co., Ltd.) and 20 mL of food-grade glycerol (purchased from Henan Wanbang Industrial Co., Ltd.), and mixed thoroughly to obtain an astaxanthin-Chinese prickly ash oil complex liquid.

3) The astaxanthin-Chinese prickly ash oil complex liquid was added into the chitosan solution, and mixed thoroughly to obtain a chitosan-Chinese prickly ash oil-astaxanthin composite preservative.

4) Fresh pig hind leg meat was processed with a sterile scalpel and a sterile cylindrical corer to obtain meat slices with a surface area of about 1.8 cm², a thickness of about 3 mm, and a weight of about 1.5 g. The surface of each meat sample was coated with 400 μL of the chitosan-Chinese prickly ash oil-astaxanthin composite preservative, air-dried for 15 min, vacuum packaged, and stored at 30° C. (simulating e-commerce logistics) for 2 d. After treatment (0 d), 1 d, and 2 d, the following indexes were sampled and evaluated:

(1) Total viable count (TVC): the TVC in sample was determined according to GB 4789.2-2016 National Food Safety Standard—Food Microbiological Examination: Aerobic Plate Count.

(2) Total volatile basic nitrogen (TVBN): the TVBN in the sample was determined according to GB 5009.228-2016 National Food Safety Standard—Determination of Volatile Basic Nitrogen in Food.

(3) Chromaticity: the chromaticity of the sample was tested with a colorimeter, including brightness L*, redness a*, and yellowness b*.

(4) Lipid oxidation: the malondialdehyde (MDA) content of the sample was detected using an MDA detection kit by a chromogenic method to evaluate the degree of lipid oxidation.

(5) Sensory evaluation: according to GB/T 9959.2-2008 Fresh and frozen pork lean, cuts, sensory evaluation was conducted on the meat samples in terms of color, texture, smell, and acceptability.

### Example 2

Except that the food-grade Haematococcus pluvialis-derived astaxanthin powder was added at 2 g, the remaining amounts were the same as those in Example 1, and a chitosan-Chinese prickly ash oil-astaxanthin composite preservative was obtained. The index evaluation was conducted the same as that in Example 1.

### Example 3

Except that the food-grade Haematococcus pluvialis-derived astaxanthin powder was added at 1 g, the remaining amounts were the same as those in Example 1, and a chitosan-Chinese prickly ash oil-astaxanthin composite preservative was obtained. The index evaluation was conducted the same as that in Example 1.

### Comparative Example 1

Except that the food-grade Haematococcus pluvialis-derived astaxanthin powder was not added, the remaining amounts were the same as those in Example 1, and a chitosan-Chinese prickly ash oil composite preservative was obtained. The index evaluation was conducted the same as that in Example 1.

### Comparative Example 2

Except that 780 mL of distilled water, 0 g of food-grade Haematococcus pluvialis-derived astaxanthin powder, and 0 mL of Chinese prickly ash oil were added, the remaining operations were the same as those in Example 1, and a chitosan preservative (with glycerol) was obtained. The index evaluation was conducted the same as that in Example 1.

### Comparative Example 3

Except that 800 mL of distilled water, 0 g of food-grade Haematococcus pluvialis-derived astaxanthin powder, 0 mL of Chinese prickly ash oil, and 0 mL of food-grade glycerol were added, the remaining operations were the same as those in Example 1, and a chitosan preservative (without glycerol) was obtained. The index evaluation was conducted the same as that in Example 1.

### Comparative Example 4

Except that 0 g of chitosan was added, the remaining operations were the same as those in Example 1, and an astaxanthin-Chinese prickly ash oil composite preservative (with glycerol) was obtained. The index evaluation was conducted the same as that in Example 1.

### Comparative Example 5

Except that 0 g of chitosan and 0 g of food-grade Haematococcus pluvialis-derived astaxanthin powder were added, the remaining operations were the same as those in Example 1, and a Chinese prickly ash oil preservative (with glycerol) was obtained. The index evaluation was conducted the same as that in Example 1.

### Comparative Example 6

Except that 0 g of chitosan, 780 mL of distilled water, and 0 mL of Chinese prickly ash oil were added, the remaining operations were the same as those in Example 1, and an astaxanthin preservative (with glycerol) was obtained. The index evaluation was conducted the same as that in Example 1.

### Comparative Example 7

Except that 0 g of chitosan, 800 mL of distilled water, 0 g of food-grade Haematococcus pluvialis-derived astaxanthin powder, 0 mL of Chinese prickly ash oil, and 0 mL of food-grade glycerol were added, the remaining operations were the same as those in Example 1, and an acetic acid preservative was obtained. The index evaluation was conducted the same as that in Example 1.

### Comparative Example 8

Except that the chitosan-Chinese prickly ash oil-astaxanthin preservative was not prepared and used, the remaining operations were the same as those in Example 1, and a blank control group was obtained. The index evaluation was conducted the same as that in Example 1.

### Test 1

Total viable count (TVC) and total volatile basic nitrogen (TVBN) are the most important indexes reflecting the degree of meat spoilage. In each of the above examples, the TVC and TVBN of the meat samples are shown in Table 1. After the meat samples were treated with chitosan-Chinese prickly ash oil-astaxanthin preservative (Examples 1 to 3), or chitosan-Chinese prickly ash oil composite preservative (Comparative Example 1), the TVC was significantly reduced by nearly 2 log CFU/g. After the meat samples were treated with chitosan preservative (Comparative Examples 2 to 3), the TVC was also significantly reduced by nearly 1 log CFU/g. However, the astaxanthin-Chinese prickly ash oil composite preservative, Chinese prickly ash oil preservative, astaxanthin preservative, or acetic acid solution in Comparative Examples 4 to 7 did not exhibit antibacterial activity in meat.

According to national food safety standards, the TVC and TVBN of qualified fresh meat must be less than 6 log CFU/g and 15 mg/100 g, respectively. After being stored at 30° C. for 2 d, the TVC of the meat sample in Comparative Example 8 (without preservative treatment) was higher than 7 log CFU/g, and the TVBN was as high as 28.5 mg/100 g. Both indexes were much higher than the values set in the national standards. The TVC and TVBN of the meat samples treated with chitosan-Chinese prickly ash oil-astaxanthin preservative were lower than the set values in the national standards. It was seen that the chitosan-Chinese prickly ash oil-astaxanthin preservative could significantly reduce the degree of spoilage in fresh meat at 30° C. (simulating room-temperature logistics). The chitosan-Chinese prickly ash oil-astaxanthin preservative in Example 1 had the most significant effect, showing an antiseptic effect significantly better than that of the treatments in Comparative Examples 4 to 7. It was seen that chitosan, astaxanthin, and Chinese prickly ash oil had synergistic effects in antisepsis.

TABLE 1
Spoilage index of meat treated with different preservatives

| | TVC (log CFU/g) | | | TVBN (mg/100 g) | | |
|---|---|---|---|---|---|---|
| Group | 0 d | 1 d | 2 d | 0 d | 1 d | 2 d |
| Example 1 | 3.3 ± 0.7^{c} | 3.6 ± 0.5^{c} | 4.2 ± 0.7^{c} | 11.8 ± 3.3^{b} | 12.5 ± 2.5^{b} | 13.6 ± 2.4^{c} |
| Example 2 | 3.4 ± 1.0^{c} | 3.5 ± 0.4^{c} | 4.4 ± 1.0^{c} | 10.5 ± 2.4^{b} | 12.3 ± 3.6^{b} | 13.8 ± 3.8^{c} |
| Example 3 | 3.3 ± 0.5^{c} | 3.9 ± 0.9^{c} | 4.8 ± 1.0^{c} | 12.2 ± 3.8^{b} | 12.9 ± 1.7^{b} | 14.2 ± 3.3^{bc} |
| Comparative | 3.5 ± 0.8^{c} | 3.8 ± 1.2^{c} | 4.6 ± 0.7^{c} | 11.5 ± 3.1^{b} | 13.7 ± 2.5^{b} | 14.9 ± 4.3^{bc} |
| Example 1 | | | | | | |
| Comparative | 4.3 ± 0.6^{b} | 5.0 ± 0.8^{b} | 5.7 ± 0.5^{b} | 13.7 ± 3.8^{b} | 14.6 ± 4.1^{b} | 17.1 ± 2.6^{b} |
| Example 2 | | | | | | |
| Comparative | 4.1 ± 0.6^{b} | 4.8 ± 0.8^{b} | 5.5 ± 0.9^{b} | 13.8 ± 2.5^{b} | 14.8 ± 2.7^{b} | 16.3 ± 3.5^{b} |
| Example 3 | | | | | | |
| Comparative | 4.5 ± 0.8^{ab} | 6.3 ± 0.2^{a} | 6.5 ± 0.7^{a} | 16.5 ± 2.8^{a} | 18.2 ± 5.5^{a} | 23.6 ± 2.4^{a} |
| Example 4 | | | | | | |
| Comparative | 4.7 ± 0.6^{ab} | 6.1 ± 0.5^{a} | 6.8 ± 0.3^{a} | 17.2 ± 5.1^{a} | 19.5 ± 2.8^{a} | 22.8 ± 4.2^{a} |
| Example 5 | | | | | | |
| Comparative | 4.8 ± 0.5^{a} | 6.4 ± 0.3^{a} | 7.0 ± 0.6^{a} | 16.8 ± 2.2^{a} | 18.1 ± 3.4^{a} | 24.9 ± 3.5^{a} |
| Example 6 | | | | | | |
| Comparative | 4.8 ± 0.8^{a} | 6.3 ± 0.7^{a} | 7.1 ± 0.3^{a} | 16.2 ± 4.5^{a} | 19.7 ± 4.2^{a} | 26.4 ± 4.8^{a} |
| Example 7 | | | | | | |
| Comparative | 5.1 ± 0.5^{a} | 6.6 ± 1.1^{a} | 7.4 ± 0.8^{a} | 17.3 ± 3.3^{a} | 23.2 ± 7.6^{a} | 28.5 ± 5.3^{a} |
| Example 8 | | | | | | |

### Test 2

Colorimetric values (L*, a*, b* values) and malondialdehyde (MDA) content are important physical and chemical indicators closely related to meat quality. The colorimetric values may reflect the freshness of meat to a certain extent, while MDA may characterize the degree of lipid oxidation of meat. In each of the above examples, the colorimetric values and MDA values of the meat samples are shown in Table 2 and Table 3, respectively. As shown in Table 2, after the meat sample was treated with chitosan-Chinese prickly ash oil-astaxanthin preservative (Examples 1 to 3), a* value (redness value) increased significantly. While b* value (yellowness value) dropped significantly. For pork, beef, and mutton, meat color of red or pink may increase consumers' desire to buy. The b* value is generally related to the degree of lipid oxidation of meat. A higher degree of lipid oxidation means a higher b* value. It was seen that the chitosan-Chinese prickly ash oil-astaxanthin preservative could significantly improve the color of fresh meat, among which the chitosan-Chinese prickly ash oil-astaxanthin preservative in Example 1 showed the best effect.

As shown in Table 3, the MDA values of the meat samples in Examples 1 to 3 were significantly lower than those in other comparative examples. This indicated that the chitosan-Chinese prickly ash oil-astaxanthin preservative could significantly delay the lipid oxidation of fresh meat, and chitosan, astaxanthin, and Chinese prickly ash oil had a synergistic effect in antioxidants.

TABLE 2
Differences in chromaticity values of different treatment groups

| | Chromaticity | | | | | | | | |
|---|---|---|---|---|---|---|---|---|---|
| | 0 d | | | 1 d | | | 2 d | | |
| Group | L* | a* | b* | L* | a* | b* | L* | a* | b* |
| Example 1 | 32.9 ± | 9.3 ± | 12.0 ± | 34.7 ± | 9.4 ± | 11.5 ± | 32.9 ± | 9.2 ± | 12.3 ± |
| | 2.5^{ab} | 0.4^{c} | 0.7^{a} | 3.0^{a} | 0.5^{c} | 0.8^{a} | 2.5^{ab} | 0.6^{c} | 0.3^{a} |
| Example 2 | 33.6 ± | 9.1 ± | 12.5 ± | 34.1 ± | 9.2 ± | 12.4 ± | 33.6 ± | 8.8 ± | 12.7 ± |
| | 3.0^{ab} | 0.7^{c} | 0.3^{a} | 2.3^{a} | 0.6^{c} | 0.7^{ab} | 3.0^{ab} | 1.0^{c} | 0.5^{ab} |
| Example 3 | 32.5 ± | 8.8 ± | 12.3 ± | 33.6 ± | 8.6 ± | 11.8 ± | 32.5 ± | 8.5 ± | 12.8 ± |
| | 1.8^{ab} | 0.2^{bc} | 0.4^{a} | 4.2^{a} | 0.8^{c} | 1.1^{a} | 1.8^{ab} | 0.8^{c} | 0.6^{ab} |
| Comparative | 35.2 ± | 6.9 ± | 13.4 ± | 36.5 ± | 6.1 ± | 12.9 ± | 35.2 ± | 5.8 ± | 13.1 ± |
| Example 1 | 2.7^{b} | 0.5^{a} | 0.5^{a} | 1.1^{a} | 0.6^{a} | 0.8^{ab} | 2.7^{b} | 0.6^{a} | 0.9^{ab} |
| Comparative | 34.1 ± | 7.3 ± | 13.3 ± | 36.4 ± | 6.5 ± | 13.6 ± | 34.1 ± | 6.7 ± | 13.5 ± |
| Example 2 | 4.4^{ab} | 0.8^{ab} | 0.9^{a} | 3.2^{a} | 1.1^{ab} | 0.5^{b} | 4.4^{b} | 1.2^{ab} | 0.4^{b} |
| Comparative | 33.5 ± | 7.2 ± | 13.0 ± | 35.8 ± | 6.8 ± | 13.4 ± | 33.5 ± | 6.3 ± | 13.3 ± |
| Example 3 | 2.5^{ab} | 0.6^{ab} | 1.2^{a} | 1.4^{a} | 0.4^{ab} | 0.6^{b} | 2.5^{ab} | 0.8^{ab} | 0.6^{ab} |
| Comparative | 32.4 ± | 9.1 ± | 12.4 ± | 33.5 ± | 9.2 ± | 12.2 ± | 31.7 ± | 8.9 ± | 12.1 ± |
| Example 4 | 3.6^{ab} | 0.8^{c} | 0.5^{a} | 2.2^{a} | 0.4^{c} | 0.5^{ab} | 5.2^{ab} | 1.2^{b} | 0.6^{a} |
| Comparative | 32.8 ± | 7.8 ± | 12.2 ± | 33.9 ± | 7.4 ± | 13.4 ± | 31.5 ± | 6.5 ± | 13.7 ± |
| Example 5 | 3.2^{ab} | 0.8^{ab} | 1.3^{a} | 2.6^{a} | 0.4^{b} | 0.3^{b} | 3.7^{a} | 1.2^{b} | 0.8^{b} |
| Comparative | 31.3 ± | 8.8 ± | 12.5 ± | 32.4 ± | 8.6 ± | 13.1 ± | 33.8 ± | 8.5 ± | 13.3 ± |
| Example 6 | 5.2^{a} | 0.6^{bc} | 0.5^{a} | 4.3^{a} | 0.3^{c} | 0.6^{b} | 4.2^{ab} | 0.4^{c} | 0.7^{b} |
| Comparative | 30.8 ± | 7.7 ± | 12.8 ± | 35.4 ± | 7.3 ± | 13.8 ± | 30.8 ± | 6.9 ± | 14.1 ± |
| Example 7 | 2.4^{a} | 0.5^{ab} | 0.7^{a} | 3.0^{a} | 1.3^{b} | 1.2^{b} | 2.4^{a} | 0.7^{b} | 0.5^{b} |
| Comparative | 31.7 ± | 8.1 ± | 13.2 ± | 34.2 ± | 7.6 ± | 13.8 ± | 31.7 ± | 6.8 ± | 13.5 ± |
| Example 8 | 3.3^{ab} | 0.3^{b} | 1.5^{a} | 2.6^{a} | 0.8^{b} | 0.6^{b} | 3.3^{a} | 0.5^{ab} | 0.7^{b} |

TABLE 3
Differences in MDA values of different treatment groups

| | MDA (nmol/mg) | | |
|---|---|---|---|
| Group | 0 d | 1 d | 2 d |
| Example 1 | 0.015 ± 0.004^{a} | 0.016 ± 0.007^{b} | 0.020 ± 0.007^{b} |
| Example 2 | 0.015 ± 0.008^{a} | 0.018 ± 0.005^{b} | 0.023 ± 0.011^{b} |
| Example 3 | 0.016 ± 0.011^{ab} | 0.021 ± 0.010^{b} | 0.025 ± 0.006^{b} |
| Comparative | 0.018 ± 0.008^{ab} | 0.028 ± 0.006^{ab} | 0.035 ± 0.010^{b} |
| Example 1 | | | |
| Comparative | 0.016 ± 0.010^{ab} | 0.026 ± 0.012^{ab} | 0.046 ± 0.012^{ab} |
| Example 2 | | | |
| Comparative | 0.018 ± 0.006^{ab} | 0.031 ± 0.008^{ab} | 0.041 ± 0.020^{ab} |
| Example 3 | | | |
| Comparative | 0.017 ± 0.011^{ab} | 0.035 ± 0.008^{ab} | 0.038 ± 0.013^{ab} |
| Example 4 | | | |
| Comparative | 0.023 ± 0.014^{ab} | 0.042 ± 0.013^{a} | 0.054 ± 0.005^{a} |
| Example 5 | | | |
| Comparative | 0.018 ± 0.006^{ab} | 0.032 ± 0.005^{ab} | 0.045 ± 0.017^{ab} |
| Example 6 | | | |
| Comparative | 0.021 ± 0.008^{ab} | 0.047 ± 0.012^{a} | 0.052 ± 0.014^{a} |
| Example 7 | | | |
| Comparative | 0.025 ± 0.012^{b} | 0.043 ± 0.007^{a} | 0.058 ± 0.025^{a} |
| Example 8 | | | |

### Test 3

The sensory evaluation results are shown in Table 5. The sensory score of the meat sample in Comparative Example 5 dropped significantly after being stored at 30° C. for 2 d, and the sensory quality deteriorated significantly. However, the sensory scores of the meat samples in Examples 1 to 3 scarcely changed before and after preservation, and the sensory quality was maintained at a high level. In addition, the sensory scores of the meat samples in Examples 1 to 3 were significantly higher than those of the meat samples in other comparative examples, especially in terms of color scores. The meat sample in Example 1 showed best sensory quality. This indicated that the chitosan-Chinese prickly ash oil-astaxanthin preservative could significantly delay the deterioration of the sensory quality of fresh meat, and was particularly effective in improving the color of fresh meat. Moreover, chitosan, astaxanthin, and Chinese prickly ash oil had a synergistic effect in improving the sensory quality of fresh meat.

TABLE 4
Sensory scoring criteria for meat samples

| Item | Sensory quality | Score |
|---|---|---|
| Color | Muscle showing bright red, with gloss | 9-10 |
| | Muscle showing slightly bright red, with gloss | 7-8 |
| | Muscle showing pink, without gloss | 5-6 |
| | Muscle showing dark or gray, without gloss | 3-4 |
| | Muscle showing brown | 0-2 |
| Texture | Tight and elastic texture, recovering | 9-10 |
| | immediately after pressing with fingers | |
| | Tight and elastic texture, recovering | 7-8 |
| | later after pressing with fingers | |
| | Common elastic texture, recovering | 5-6 |
| | slowly after pressing with fingers | |
| | No elastic texture, no recovering | 3-4 |
| | after pressing with fingers | |
| | Completely no elastic texture, showing obvious | 0-2 |
| | depression after pressing with fingers | |
| Smell | Unique smell of fresh pork, no peculiar smell | 9-10 |
| | Unique smell of pork, light | 7-8 |
| | additive smell, no peculiar smell | |
| | Slightly heavy additive smell, no peculiar smell | 5-6 |
| | With ammonia smell, heavy additive smell | 3-4 |
| | Putrefactive smell | 0-2 |

TABLE 5
Sensory quality score results

| | 0 d | | | 2 d | | |
|---|---|---|---|---|---|---|
| Group | color | Texture | Smell | color | Texture | Smell |
| Example 1 | 8.5 ± 0.6^{c} | 8.0 ± 0.4^{a} | 7.8 ± 0.2^{a} | 8.1 ± 0.3^{d} | 7.5 ± 0.2^{c} | 7.0 ± 0.2^{c} |
| Example 2 | 8.0 ± 0.4^{b} | 7.7 ± 0.1^{a} | 7.4 ± 0.3^{a} | 7.6 ± 0.2^{cd} | 7.2 ± 0.1^{c} | 6.6 ± 0.1^{bc} |
| Example 3 | 7.6 ± 0.2^{b} | 7.7 ± 0.3^{a} | 7.6 ± 0.3^{a} | 7.1 ± 0.2^{c} | 6.9 ± 0.3^{bc} | 6.8 ± 0.2^{c} |
| Comparative | 5.9 ± 0.5^{a} | 7.8 ± 0.2^{a} | 7.2 ± 0.1^{a} | 5.0 ± 0.2^{b} | 6.5 ± 0.3^{bc} | 6.5 ± 0.3^{bc} |
| Example 1 | | | | | | |
| Comparative | 6.0 ± 0.3^{a} | 7.7 ± 0.3^{a} | 7.4 ± 0.2^{a} | 4.8 ± 0.1^{b} | 6.1 ± 0.2^{b} | 6.3 ± 0.2^{bc} |
| Example 2 | | | | | | |
| Comparative | 6.3 ± 0.4^{a} | 7.5 ± 0.1^{a} | 7.3 ± 0.2^{a} | 5.1 ± 0.3^{b} | 6.0 ± 0.1^{b} | 5.9 ± 0.2^{b} |
| Example 3 | | | | | | |
| Comparative | 7.5 ± 0.7^{b} | 7.5 ± 0.6^{a} | 7.7 ± 0.4^{a} | 7.3 ± 0.8^{cd} | 5.2 ± 0.3^{a} | 4.6 ± 0.3^{a} |
| Example 4 | | | | | | |
| Comparative | 6.2 ± 0.4^{a} | 7.3 ± 0.8^{a} | 7.3 ± 0.2^{a} | 3.5 ± 0.7^{a} | 4.9 ± 0.3^{a} | 4.7 ± 0.5^{a} |
| Example 5 | | | | | | |
| Comparative | 7.3 ± 0.5^{b} | 7.2 ± 0.4^{a} | 7.4 ± 0.5^{a} | 6.8 ± 0.7^{c} | 5.4 ± 0.6^{a} | 4.5 ± 0.7^{a} |
| Example 6 | | | | | | |
| Comparative | 6.1 ± 0.5^{a} | 6.9 ± 0.5^{a} | 7.1 ± 0.1^{a} | 3.2 ± 0.4^{a} | 5.2 ± 0.3^{a} | 4.8 ± 0.4^{a} |
| Example 7 | | | | | | |
| Comparative | 5.8 ± 0.3^{a} | 7.3 ± 0.2^{a} | 7.6 ± 0.2^{a} | 2.9 ± 0.1^{a} | 4.8 ± 0.4^{a} | 4.2 ± 0.1^{a} |
| Example 8 | | | | | | |

In summary, the chitosan-Chinese prickly ash oil-astaxanthin preservative in the present disclosure has a strong meat preservation effect, and may significantly delay the spoilage of fresh meat, thus effectively improving the safety and quality of fresh meat.

Although the above example has described the present disclosure in detail, it is only a part of, not all of, the embodiments of the present disclosure. Other examples may also be obtained by persons based on the example without creative efforts, and all of these examples shall fall within the protection scope of the present disclosure.

Various embodiments of the disclosure may have one or more of the following effects. In some embodiments, compared with other chemical antiseptic preservatives, the food preservative in the present disclosure may better protect the health and better meet the consumption needs of consumers. In some examples, the food preservative may have an antiseptic and preservative effect better than that of existing commercial meat preservatives, and may be more cost-effective than most similar products. The preparation method may be efficient, novel, simple, easy to implement, and suitable for large-scale industrial production, and may show promising industrialization prospects.

In other embodiments, the present disclosure may provide a food preservative, including chitosan, Chinese prickly ash oil, and astaxanthin that have both antibacterial and antioxidant activities, and may significantly reduce a degree of meat spoilage and delay lipid oxidation. The Chinese prickly ash oil may also improve the flavor of meat. While the astaxanthin is a natural red pigment that may improve the color of pork, beef, and mutton, thereby enhancing their sensory quality. The raw materials of the preservative according to the present disclosure all belong to food-grade ingredients that are beneficial to human health with a low cost. Therefore, compared with other chemical antiseptic preservatives, the food preservative in the present disclosure may better protect the health and better meet the consumption needs of consumers. It has been confirmed by examples that the food preservative has an antiseptic and preservative effect better than that of existing commercial meat preservatives, and is more cost-effective than most similar products. The preparation method may be efficient, novel, simple, easy to implement, and suitable for large-scale industrial production, and has promising industrialization prospects.

In further embodiments, the present disclosure may provide a food preservative, a method of preparation thereof, and a method of room-temperature preservation, which may help to effectively improve the safety and quality of meat, may be suitable for the room-temperature logistics transportation of emerging e-commerce, and may be used to extend a shelf life of the meat in e-commerce.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various FIGURES need be carried out in the specific order described.

The disclosure claimed is:

1. A food preservative, comprising Chinese prickly ash oil, chitosan, and astaxanthin.

2. The food preservative according to claim 1, further comprising glycerol, acetic acid, and water.

3. The food preservative according to claim 2, wherein:
the glycerol, the acetic acid, and the water are at a volume ratio of 5-30:5-25:915-985; and
the chitosan and the water are at a mass-volume ratio of 5-20 g:915-985 mL.

4. The food preservative according to claim 1, wherein the Chinese prickly ash oil, the chitosan, and the astaxanthin are at a volume-mass-mass ratio of 5-30 mL:5-20 g:0.01-0.06 g.

5. A method for preparing the food preservative according to claim 1, comprising:
mixing chitosan with acetic acid and water to obtain a chitosan solution;
mixing the Chinese prickly ash oil, glycerol, and the astaxanthin to obtain a complex liquid; and
mixing the chitosan solution with the complex liquid to obtain a chitosan-Chinese prickly ash oil-astaxanthin composite preservative.

6. The method according to claim 5, wherein the food preservative further comprises glycerol, acetic acid, and water.

7. The method according to claim 6, wherein:
the glycerol, the acetic acid, and the water are at a volume ratio of 5-30:5-25:915-985; and
the chitosan and the water are at a mass-volume ratio of 5-20 g:915-985 mL.

8. The method according to claim 7, wherein the food preservative further comprises glycerol, acetic acid, and water.

9. The method according to claim 8, wherein:
the glycerol, the acetic acid, and the water are at a volume ratio of 5-30:5-25:915-985; and
the chitosan and the water are at a mass-volume ratio of 5-20 g:915-985 mL.

10. The method according to claim 7, wherein the Chinese prickly ash oil, the chitosan, and the astaxanthin are at a volume-mass-mass ratio of 5-30 mL:5-20 g:0.01-0.06 g.

11. The method according to claim 5, wherein the chitosan solution comprises 5 g/L to 20 g/L of chitosan by concentration.

12. The method according to claim 5, wherein the Chinese prickly ash oil, the chitosan, and the astaxanthin are at a volume-mass-mass ratio of 5-30 mL:5-20 g:0.01-0.06 g.

13. A method of room-temperature preservation of a food product, comprising: coating the food preservative according to claim 1 on a surface of the food product, air-drying, and packaging.

14. The method according to claim 13, wherein the food product comprises a meat product.

15. The method according to claim 14, wherein 400 μL of the food preservative is coated on per 1 g to 2 g of the meat product.

16. The method according to claim 13, further comprising vacuum packaging after the air-drying is completed.
